(19) United States
(12) Patent Application Publication
(10) Pub. No.: US 2006/0166050 A1
(43) Pub. Date: Jul. 27, 2006

(54) Fuel cell system and method for operating a fuel cell system

(76) Inventor: Rainer Autenrieth, Grossbottwar (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/541,212

(22) PCT Filed: Dec. 30, 2003
(86) PCT No.: PCT/DE04/00002

§ 371 Date: Mar. 16, 2006

(30) Foreign Application Priority Data
Dec. 30, 2002 (DE) 102 61 418.0

(51) Int. Cl. H01M 16/00; H02J 7/32

(52) U.S. Cl. 429/13; 429/9; 320/101

(57) ABSTRACT

A fuel cell system for supplying at least one electric load with electric power includes at least one fuel cell and an energy storage device, and also a switching device for disconnecting and connecting the fuel cell system from and to the at least one load. The switching device has at least two switches, so that the fuel cell and the energy storage device can be disconnected and connected from and to the at least one electric load independently of one another. In addition, a method is provided for operating such a fuel cell system.

The invention relates to a method for operating a fuel cell system of the type defined more precisely in the precharacterizing clause of claim 1, and to a fuel cell system of the type defined more precisely in the precharacterizing clause of claim 9.

A corresponding fuel cell system is known from EP 0 782 209 A1. This fuel cell system has a battery, to allow the intrinsically comparatively slow-reacting fuel cell to be used in systems which have very high dynamic requirements for the provision of power.

In principle, when coupling fuel cells and a battery, the existing characteristic curves of the fuel cell and the, by comparison, inflexible characteristic curve of the battery produce an operating point corresponding to the point of intersection of these curves. However, this operating point is often not desired, since it involves correspondingly high currents for charging the battery or since the fuel cell is not used under optimum operating conditions. As a result, the efficiency of the system is impaired because of the comparatively high internal resistance of the battery and the unfavorable operating conditions of the fuel cell.

In the aforementioned EP 0 782 209 A1, a system which comprises a resonant circuit, a transformer and a rectifier and in principle is constructed in the manner of a DC/DC converter is now used between the battery and the fuel cell. This DC/DC converter allows the characteristic curves of the fuel cell and of the battery to be decoupled completely from one another and allows the most favorable operating conditions to be respectively set for the battery and the fuel cell without the elements detrimentally influencing one another.

However, the construction with the DC/DC converter represents a serious disadvantage in the mass production of such systems, for example for use in motor vehicles. DC/DC converters are comparatively susceptible to faults, need a relatively large installation space and are very expensive, so that the system altogether becomes much more expensive, which has serious effects on the cost-effectiveness of such systems, for example for the aforementioned case in which fuel cell systems are used in a motor vehicle, because of the comparatively high numbers of units to be expected.

WO 01/91214 A1 and, achieving an ultimately similar effect for the load, WO 00/79623 A1 disclose fuel cell systems which can use pulsed operation of the fuel cell to draw high power from it. These systems are in fact based on the use of a certain inherent capacitive property of the fuel cell to increase the power characteristics by pulsed operation. By contrast with the operation described above with a DC/DC converter, however, these purely pulse-based modes of operation do not allow any flexibility with regard to the power to be drawn from the fuel cell. It also appears to be disadvantageous in the case of the combination with a battery that the battery is subjected to very intensive loading because of the high currents during charging, and consequently corresponding losses are unavoidable.

For further prior art, reference is also to be made to DE 100 56 429 A1. In the case of these fuel cell systems, the drawing of electric power from the fuel cell takes place in each case on a switched-mode basis by means of a switching device or a switch between the system and a load, the switched mode having the effect that the system responds to the presence or absence of fuel in the fuel cell, in particular in its anode region, with respect to the power respectively required from the fuel cell. The pressure in the region of the fuel cell, or in the anode region of the fuel cell, may be used for example as a parameter for the fuel available in the fuel cell.

As further general prior art, DE 101 25 106 A1 describes a fuel cell system with a fuel cell and an energy storage device. The energy storage device in this case comprises at least one battery and an intermediate charge store with a lower internal resistance than the battery.

The object of the invention is to provide a fuel cell system and a method for operating this fuel cell system which avoids the aforementioned disadvantages of the prior art and represents a low-cost, robust, reliably operating high-performance fuel cell system.

This object is achieved according to the invention by the method described by the features in the characterizing clause of claim 1. A corresponding fuel cell system for achieving the object stated above is provided by the features in the characterizing clause of claim 9.

Both the fuel cell system and the method for its operation allow the fuel cell system to be designed and operated in a highly flexible manner with minimal means, to be specific two switches, for example electronic switches such as MOSFETs or the like. Although similar flexibility could be achieved with the aid of a DC/DC converter, this would always entail the disadvantages already described at the beginning.

The simple and extremely robust fuel cell system according to the invention allows the inherent properties of the individual components to be ideally matched to one another at their individual operating points in periodic repetition by specifically selective actuation of the at least two switches, for example on the basis of measurable events. The electric power losses occurring in the fuel cell system can be minimized in this way, with best possible performance. This has the ultimate effect that the system efficiency can be increased by means of such a method.

Furthermore, in the case of the fuel cell system according to the invention, no power adaptation of individual components has to take place in the design of the system, since the distribution of the power required and generated, for example by the pulse widths of the opening of the individual switches, can be realized in its operation by corresponding switch positions. In this way, adaptation of the system to different states, for example dynamically changing load states during operation, is also very easily possible. This can also ultimately contribute to the increased performance of the fuel cell system.

In principle, the method according to the invention and/or the fuel cell system according to the invention can be meaningfully used in any form of use for the same. It is immaterial here whether the fuel cell system is operated as a stationary or mobile fuel cell system, or whether it is operated directly with hydrogen or with a hydrogen-containing gas generated from the fuel in a gas generating device. However, it is particularly advantageous to use such a system in a mobile fuel cell system, in particular in a motor vehicle.

Such systems, which can be used in motor vehicles or similar kinds of vessel or craft on water or land or in the air, can serve for the onboard power supply of such a vehicle. They are then generally referred to as an auxiliary power unit or APU. In these systems, but also in fuel cell systems which are designed for driving the mobile system, the method according to the invention can be used particularly favorably, since very frequently changing and highly dynamic requirements for the power to be provided by the fuel cell are involved here. The invention allows this to be realized with best possible efficiency and high flexibility at low prime costs for the electronics.

Further particularly favorable configurational variants of the invention are provided by the subclaims and become clear from the exemplary embodiment, which is explained in more detail below with reference to the figures, in which:

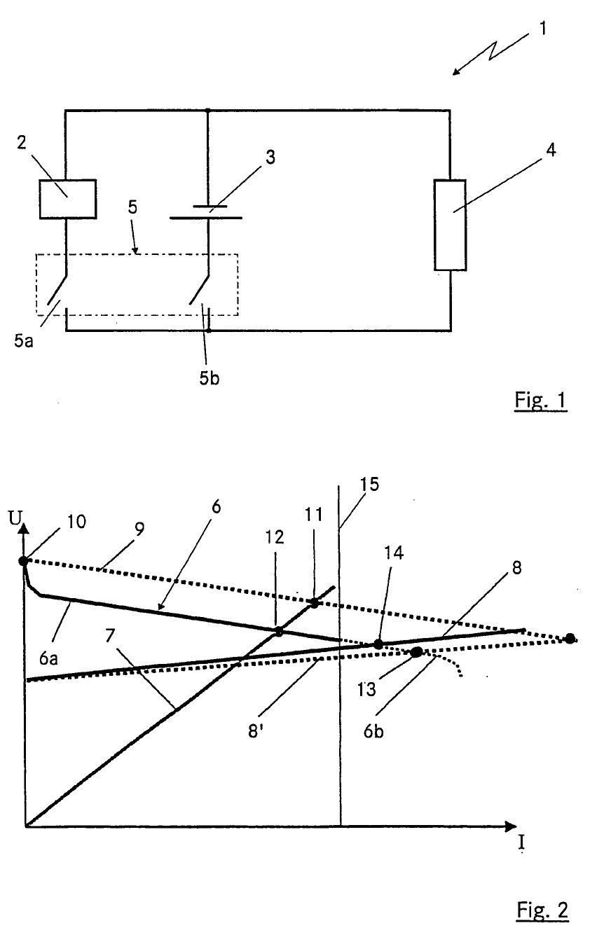

FIG. 1 shows a schematic representation of a possible construction of the fuel cell system according to the invention;

FIG. 2 shows a current-voltage diagram with the characteristic curves of the components of the fuel cell system according to the invention;

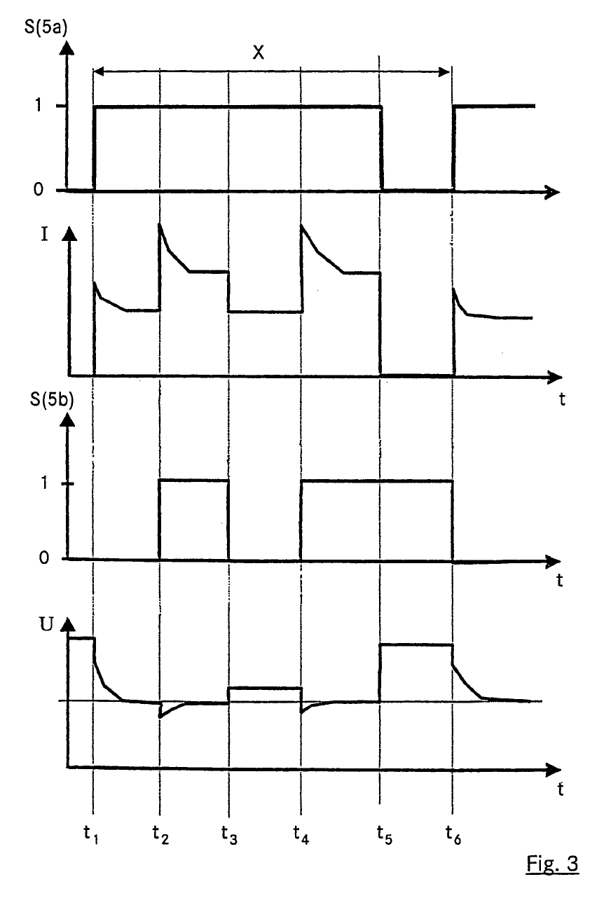

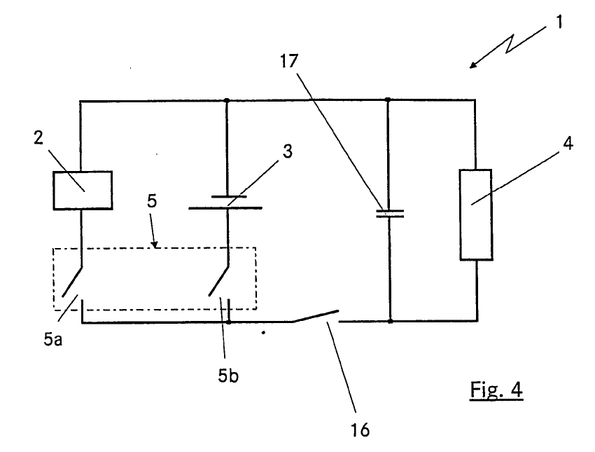

FIG. 3 shows a variation over time, given by way of example, of the parameters relevant to the method according to the invention; and

FIG. 4 shows a schematic representation of an alternative possible construction of the fuel cell system according to the invention.

Represented in principle in FIG. 1 is a fuel cell system 1 which comprises not only a fuel cell 2 but also an energy storage device 3 and at least one electric load 4.

The fuel cell 2 may be understood as meaning both an individual fuel cell and a fuel cell stack made up of a multiplicity of fuel cells. It is to be understood preferably, but not restrictively, within the scope of the invention as meaning a fuel cell or a fuel cell stack in a configuration with proton-conducting membranes (PEM). A comparable statement also applies analogously to the energy storage device 3, which is to be designed for example as a battery. It is assumed to be self-evident that this battery is then made up of a multiplicity of individual battery cells in the customary way. Other types of configuration of the energy storage device 3, for example as a thin-film storage capacitor or supercap, individually or made up of a multiplicity of individual components, are also possible however. The load 4 may be understood as meaning both an individual electric load and a multiplicity of such loads, in particular in the electrical system of a vehicle, which may, but does not have to, comprise an electric drive.

Apart from these components 2, 3, 4, the fuel cell system 1 also comprises a switching device 5 with two switches 5a, 5b, by which the fuel cell 2 and the energy storage device 3 can be periodically connected and disconnected to and from the at least one electric load 4 independently of one another. The switches 5a, 5b may in principle be formed here in any way desired, it being particularly appropriate for them to be formed as electronic switches 5a, 5b, for example on the basis of MOSFETs, because of the easy and rapid activating capability.

The activation of the two switches 5a, 5b in this case always aims to minimize power losses while ideally supplying the load 4, and in this way ultimately increasing the efficiency of the system. The following variants of the method are particularly well suited for this, individually or in any desired combinations.

For example, if more power than the load 4 requires is generated by the fuel cell 2, the energy storage device 3 can be additionally connected by means of the switch 5b in order to store the excess power. The switch 5b can in this case be switched in pulsed operation. Excess power is consequently no longer lost, but can be beneficially used in the fuel cell system 1 at a later point in time when it is required.

In principle, when charging the energy storage device 3, in particular if it is constructed as a battery, for example on the basis of lead, lithium, nickel-metal hydride or the like, it can be switched in a pulsed manner to the other components, the duration of each power pulse being shorter than the duration of the discharge of an internal capacitance specific to the energy storage device 3.

In this case, or else when using a parallel connection of the battery and a charge store, for example a thin-film capacitor (so-called supercap), as the energy storage device 3, it is possible by the pulsed charging to minimize the power loss in the battery or at its internal resistance by periodic closing and opening of the switch 5b. By storing high power peaks in the capacitance (of the battery and/or of the external charge store), these are stored in the battery “slowly” and with lower currents. The unavoidable losses at its internal resistance fall, because of the “smoothed” current peaks.

For a comparable reason, the energy storage device 3 is disconnected from the other components 2, 4 at least whenever voltage peaks occur when the fuel cell 2 is additionally connected, and is reconnected to the other components at the earliest when these voltage peaks have subsided.

If a battery is used as the energy storage device 3, or the energy storage device 3 at least has such a battery as one of its parts, the energy storage device 3 can be disconnected from the remaining components 2, 3 by the switch 5b above and below predetermined threshold voltages.

Although this procedure does not achieve a minimization of losses, it nevertheless ultimately serves for increasing the performance of the fuel cell system 1. This is so because the threshold voltages can be chosen in dependence on the battery properties in such a way that both overcharging and exhaustive discharging can be avoided. This serves in particular for extending the service life of the usually expensive and, depending on the particular type, correspondingly sensitive batteries, for example lead-acid batteries. This allows a very easy response to the problem of overcharging. This problem primarily occurs when the battery has been chosen to be small or very small in relation to the fuel cell 2 for reasons of space and cost, as is often the case for a mobile application.

Irrespective of the type of energy storage device 3 that is used, it is favorable for optimum supplying of the load 4 if it can be ensured without any interruptions. For this purpose, the energy storage device 3 is connected to the load 4 at least whenever the latter requires electric power, and when the fuel cell 2 is not connected to the load 4.

Apart from the uninterrupted supplying of the load with power, there is also good utilization of the energy stored in the energy storage device 3 when there is excess power or the like.

According to a very favorable development, the switches 5a, 5b may be switched in such a way that the system is switched back and forth between different operating states, to be precise in such a way that an optimized operating range of the fuel cell system 1 with regard to power and efficiency is established on average over time. This procedure is to be illustrated below by an example on the basis of the characteristic curves that are represented in FIG. 2.

The current(I)-voltage(U) diagram shows a characteristic curve 6 of the fuel cell 2 together with a characteristic curve 7 of the electric load 4. The characteristic curve 6 of the fuel cell 2 is subdivided into two different regions 6a, 6b, the characteristic curve 6 of the fuel cell 2 for supplying with fuel with a stationary restriction being represented in the first region 6a. The region 6b of the characteristic curve 6, indicated by dashed lines, would represent the characteristic curve 6 occurring in principle for supplying with a higher level of fuel. A further characteristic curve 8 is representative of the load in combination with the energy storage device 3. If allowance is also made for the capacitance, which for example is inherent in a battery as an energy storage device 3, the characteristic curve 8′ is obtained.

Apart from the static characteristic curve 6, already referred to above, of the fuel cell 2 in the current-voltage diagram of FIG. 2, a characteristic curve 9 of the fuel cell 2 which is obtained immediately after switching on the same is also considered, with allowance for the capacitance inherent to the fuel cell 2. Apart from the characteristic curves 6, 7, 8, 9, the operating points that are obtained at their points of intersection and the points of intersection with the axes can also be seen in the current-voltage diagram of FIG. 2. For example, the point of intersection of the characteristic curve 6 or 9 with the voltage axis U provides the point 10, which symbolizes the switched-off state of the fuel cell 2. These operating points are explained in detail below with reference to FIG. 2 and FIG. 3, although the contents of FIG. 3 are to be briefly explained first.

In FIG. 3, the parameters that are characteristic of the method described below are respectively represented in a variation over time in four individual diagrams. In the first of the diagrams, the switch position S of the switch 5a is represented over time t. Since, for safety considerations, the switch 5a and similarly the switch 5b are ideally designed in such a way that they close when they are supplied with current, here the state 1 symbolizes the closed switch 5a, the state 0 the opened switch. The switch 5a is in this way therefore closed from the point in time t₁ to the point in time t₅; the fuel cell 2 is connected to the load 4. By contrast, between the points in time t₅ and t₆, the switch 5a is open.

The second diagram shows the current I from the fuel cell 2 over time t, while the third diagram again shows a switch state S, in this case that of the switch 5b by analogy with the above diagram. In the lowermost diagram, finally, the voltage U from the fuel cell 2 is plotted against time t.

Without explicitly referring to the diagrams of FIG. 3, the method mentioned above is now described with implicit reference to FIG. 3 on the basis of the characteristic curves 6, 7, 8, 9 represented in FIG. 2.

If the fuel cell 2 is switched on with the load 4 additionally connected and the energy storage device 3 switched off (switch 5a closed=state 1 and switch 5b open=state 0), starting from the point 10 explained above, at first an operating point 11 will be established, as the point of intersection of the characteristic curves 7 and 9. This will then shift to the point of intersection 12 with the static characteristic curve 6 of the fuel cell 2. If the energy storage device 3 is then additionally connected by closing the switch 5b, at first the point 13, then the steady-state operating point 14 are established. By switching off the energy storage device 3 (switch 5b=state 0), the “loop” 12, 13, 14 can then be repeated. In order to reduce the losses at the internal resistance of the battery, the switched-on duration of the energy storage device 3 can be chosen by analogy with the statements already made above to be so short that the point 14 is in fact never reached, but instead switching back to point 12 already takes place just before this, that is to say shortly before the inherent capacitance of the energy storage device 3 has fully charged.

If the fuel cell 2 is switched off, as may become necessary for example for control reasons, as are described in the aforementioned DE 100 54 429 A1, supplying of the load 4 can be maintained by the energy storage device 3. At the point in time t₆, the point in time of renewed additional connection of the fuel cell 2 by means of closing the switch 5a, a repeat cycle X begins once again in the case described here. The regular switching off of the fuel cell 2 also allows the high voltages produced by switching on again to be ideally used for boosting the voltage on the basis of the inherent capacitance of the fuel cell 2.

Considered on average over time, with a procedure such as that described, a system efficiency that is above the efficiency of steady-state operation is established. Since it is also possible to dispense with DC/DC converters or the like, parasitic losses can be reduced, and similarly so can the required installation space and costs. On average over time, the fuel cell system 1 operated in this way uses as much hydrogen as corresponds to the current equivalent designated by 15.

Irrespective of how the switches 5a, 5b are ultimately switched, it is always advisable to change the switching frequency with which the switches 5a, 5b are actuated, or the individual switching periods run, in dependence on the power required by the load 4. In principle, the switching frequency is in this case to be chosen to be as high as possible, in order to be able to use the voltage boosting on the basis of the inherent capacitance of the fuel cell 2 as ideally as possible. Since, however, with increasing load, the losses at the switches 5a, 5b increase, the switching frequency is lowered as the load or power requirement by the load 4 increases, in order to reduce these losses.

A further variant of the fuel cell system 1 is described by FIG. 4. The main differences from the configuration according to FIG. 1 are a further switch 16 and an optional charge store 17, which may be configured for example as a supercap, parallel to the load 4.

The further switch 16 allows the fuel cell system 1 to be operated even more flexibly. For example, the load 4 may be disconnected completely from the remaining components 2, 3, so that for example charging of the energy storage device 3 is possible via the fuel cell 2, completely independently of the load 4.

The optional charge store 17, which in the case of the configurations according to FIG. 4 can be switched together with the load 4, can also be used in the case of the configuration without the further switch 16. Voltage peaks are smoothed by this optional charge store 17. Furthermore, the charge store 17 ensures that the pulsed power arrives at the load 4 in a distinctly smoothed form. Losses, for example in resistances, caused by current or voltage peaks, which may occur for example when the fuel cell 2 is additionally connected, can in this way always be reduced to the average value of the current. The loading of the load by the current peaks is reduced and the susceptibility to faults is reduced.

Otherwise, the configuration of the fuel cell system 1 according to the representation in FIG. 4 can be operated in a way analogous to the fuel cell system 1 of FIG. 1 described above.

To sum up, the invention can therefore relate to a fuel cell system 1 for supplying at least one electric load with electric power, comprising at least one fuel cell and an energy storage device, and also a switching device for disconnecting and connecting the fuel cell system from/to the at least one load. The switching device may have at least two switches, so that the fuel cell and the energy storage device can be disconnected and connected from and to the at least one electric load independently of one another. The invention can also relate to a method for operating such a fuel cell system in which the switches are periodically actuated.

The invention may, but does not necessarily have to, be used in mobile fuel cell systems, for example as a drive or as an APU for a vehicle.

1-15. (canceled)

16. A method for operating a fuel cell system including a fuel cell and an energy storage device for supplying an electric load with electric power, the method comprising:
periodically connecting and disconnecting the fuel cell with the electric load using a first switch; and
periodically connecting and disconnecting the energy storage device with the electric load using a second switch, wherein the first and second switches are disposed in a switching device and operate independently of one another.

17. The method as recited in claim 16, further comprising connecting the energy storage device to the fuel cell in a pulsed manner so as to store excess power when more power is generated by the fuel cell than is required by the electric load.

18. The method as recited in claim 16, further comprising connecting the energy storage device to the electric load when the electric load requires electric power, and when the fuel cell is not connected to the electric load.

19. The method as recited in claim 16, further comprising disconnecting the energy storage device from fuel cell and the electric load when a voltage peak occurs and reconnecting the energy storage device to the fuel cell and the electric load after the voltage peak has subsided.

20. The method as recited in claim 16, further comprising switching the energy storage device in a pulsed manner to at least one of the electric load and the fuel cell during a charging of the energy storage device, wherein a duration of each power pulse is shorter than a duration of a discharge of an internal capacitance associated with the energy storage device.

21. The method as recited in claim 16, wherein the switching is performed which only when charging the energy storage device at a high charging power level.

22. The method as recited in claim 16, wherein the energy storage device is disconnected from the electric load using the second switch above a first predetermined threshold voltage and below a second predetermined threshold voltage.

23. The method as recited in claim 16, wherein connecting and disconnecting using the first and second switcher is performed so as to switch the fuel cell system between a plurality of operating states such that an optimized operating range of the fuel cell system is established on average over time with regard to power and efficiency.

24. The method as recited in claim 16, further comprising changing a switching frequency for actuating the first and second switches as a function of a power requirement of the load.

25. A fuel cell system, comprising:
a fuel cell for supplying an electric load with power;
an energy storage device; and
a switching device having at least two switches configured to connect and disconnect the fuel cell and the energy storage device with the electric load independently of one another.

26. The fuel cell system as recited in claim 25, wherein the switching device includes a third switch for connecting and disconnecting the electric load with the energy storage device and the fuel cell.

27. The fuel cell system as recited in claim 25, wherein the energy storage device includes a battery.

28. The fuel cell system as recited in claim 26, further comprising a charge store connected parallel to the electric load.

29. The fuel cell system as recited in claim 28, wherein the third switch is disposed between the charge store on one side and the fuel cell and energy storage device on the other side, so that the charge store and the electric load are always connected.

30. The fuel cell system as recited in claim 28, wherein the charge store includes a supercap.

31. The fuel cell system as recited in claim 28, wherein the fuel cell is disposed on a motor vehicle.
